(19) United States
(12) Patent Application Publication
(10) Pub. No.: US 2007/0225461 A1
(43) Pub. Date: Sep. 27, 2007

(54) Olefin polymers for imaging members

(76) Inventor: Scott Daniel Reeves, Louisville, CO (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/386,588

(22) Filed: Mar. 22, 2006

(51) Int. Cl. C08F 36/00; B05D 5/12; B05D 7/00

(52) U.S. Cl. 526/282; 427/74; 427/407.1

(57) ABSTRACT

The present invention relates to an imaging member such as a photoconductor that includes an olefin based polymer. The olefin based polymer may be formed from a metathesis polymerization of an olefin or the chain polymerization of a cycloolefin. A method is also disclosed including the formation of a solution for coating a photoconductive surface. The method involves the addition of the olefin based polymer to a solvent followed by coating of a photoconductive surface which coating may then serve as a charge transport layer within an image forming device.

### FIELD OF INVENTION

The present invention relates to an image forming apparatus containing an olefin based polymer that may be incorporated onto a photoconductor surface which may therefore improve durability and performance.

### BACKGROUND

Imaging members may generally be used in an image forming apparatus to transfer toner either directly or indirectly onto media. In an exemplary image forming process the imaging member may be uniformly charged and then selectively discharged to form a latent image. The image may then be “developed” by the attraction of an image forming substance, such as toner, to either the charged or discharged portion of the imaging member depending upon the relative electrostatic charges of the imaging member surface and the toner. The toner may then be transferred onto a sheet of media to form an image due to the relative electrostatic charge applied to the media or to a transfer member proximate to the media. This may then be followed by a fusing process to form a printed sheet of media.

### SUMMARY

In one aspect the present invention relates to a photoconductor comprising an olefin based polymer wherein the olefin based polymer is a polymer formed from a metathesis polymerization of an olefin or chain polymerization of a cycloolefin. The present invention also relates to a method of forming a solution for coating a photoconductive surface. The method may include the steps of adding to a solvent a polymer formed from a metathesis polymerization of an olefin monomer or chain polymerization of a cycloolefin. This may then be followed by coating of a photoconductive surface. The photoconductive surface may include a charge generation layer (CGL) and charge transport layer (CTL) and the olefin based polymer may form part of the charge transport layer.

### BRIEF DESCRIPTION OF DRAWINGS

The detailed description below may be better understood with reference to the accompanying figure which is provided for illustrative purposes and are not to be considered as limiting any aspect of the invention.

FIG. 1 is cross-sectional view of an exemplary embodiment of an imaging member of the present invention. Other imaging members are contemplated as noted herein.

### DETAILED DESCRIPTION

The present invention relates to an image forming apparatus that employs an olefin based polymer that may be incorporated into a photoconductor. The image forming apparatus may include an electrophotographic printer, inkjet printer, copier, fax, all-in-one device or multi-functional device.

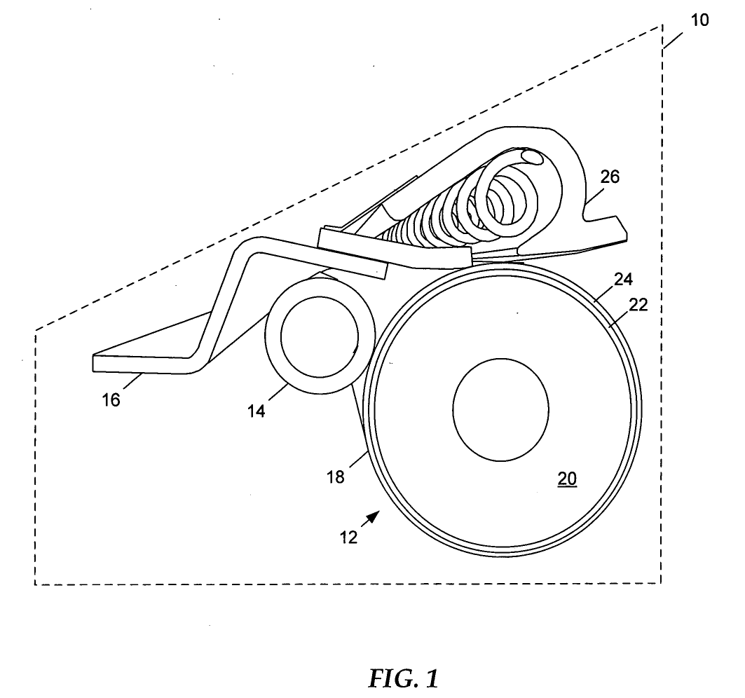

FIG. 1 illustrates an exemplary imaging transfer assembly 10. The assembly 10 may be included in a printer cartridge and may specifically use toner to produce images on a printable media. However, in some implementations, image transfer assembly 10 may utilize other image producing substances (e.g., ink, dye, wax, etc.) individually or in combination with toner. Image transfer assembly 10 may include a photoconductor drum 12 that may be partially electrically charged and may subsequently be exposed to light to create a latent electrostatic image to attract toner. In a charged-area-development (CAD) system, toner may be attracted to a portion of the drum that remains charged. In a discharged-area-development (DAD) system, toner may be attracted to discharged portions of the drum. However, in some embodiments, image transfer assembly 10 may include other types of image transfer devices that transfer an image to a print media. For example, other photoconductive image transfer devices (e.g., a photoconductive belt, a photoconductive panel, a photoconductive surface, etc.) or any other type of transfer device (e.g., ink jet, etc.) may be implemented.

Once present on the photoconductor 12, the toner may be transferred to print media such as paper. To attract toner, an electrical charge may be provided to photoconductor drum 12 by a charge roller 14 that may be in electrical contact via an electrically conductive bracket 16 to provide an electrical charge. Typically, the power supply may be located within the printing device. As photoconductor drum 16 rotates outer surface 18 of the photoconductor drum may be charged by the charge roll 14. Subsequently, the photoconductor drum is exposed to a light source such as a laser or other pattern-forming device (not shown). Patterns (e.g., that may correspond to text, graphics, etc.) may be formed as latent electrostatic images on the photoconductor surface. As the photoconductor drum continues to rotate, toner may then be developed onto the latent electrostatic image from a developer unit (not shown) and create visible toned images on the drum surface.

The photoconductive drum 12 may include an electrically conductive inner support structure 20. The conductive inner support structure 20 may be a cylinder of metallic material. It may therefore be formed entirely of a conductive material such as aluminum, including anodized aluminum, stainless steel, copper, gold, iron, titanium, lead, silver, nickel, platinum, etc. The substrate may also include a backing layer incorporating a conductive coating on top. Exemplary backing layers upon which conductive materials may be coated may include a polymeric material, such as polyester (Mylar®), polyamide, polyetherimide, as well as various other materials, alloys, blends, and copolymers thereof. The conductive coatings may include conductive materials such as aluminum, gold, copper, as well as others mentioned herein, tin oxide or indium oxide and various other materials, alloys and blends thereof.

Sandwiched between the conductive inner structure 20 and the outer surface 18 may be a charge generation layer (CGL). CGL layer 22 may therefore serve to generate positive and negative charges when exposed to light. The charge generation layer 22 may be understood as a layer which absorbs light and generates electron-hole pairs. The charge generation layer may be in the range of 0.05-5 microns in thickness, including all values and ranges therein. The charge generation layer may be applied to the imaging member by a number of coating methods, including dip coating.

The charge generation layer may include a photosensitive or charge generation molecule doped in a polymeric binder, such as polyvinyl butyral. Other polymeric binders may include polycarbonates, polyesterpolycarbonates, vinyl polymers, polyvinyl chloride, polyvinyl acetate, styrene polymers, acrylic acid polymers, acrylate polymers, polyesters, alkyds, polyamides, polyurethanes, epoxies, copolymers and blends thereof, as well as various other polymers. Exemplary charge generation or photosensitive molecules may include pigments or organic dyes, including, but not limited to azo pigments, perylenes, tris and tetrakis compounds, phthalocyanines, squaraines, as well as various other materials and blends thereof. For example, phthalocyanines may be metal free or metal containing such as type I and type IV titanyl phthalocyanines. The charge generation molecules may be present between 10-90% by weight of the charge generation layer composition, including all ranges and values therein.

A charge transport layer (CTL) may then be provided and be capable of transporting either positive or negative charges that are produced when the CGL layer is exposed to light. Furthermore, the charge transport layer 24 may be understood as a layer that assists in the migration of charge to the photoconductor surface. The charge transport layer may be between about 5-50 microns in thickness and may be applied to the charge generation layer or substrate via a number of known coating methods, such as dip coating. In addition, the image transfer assembly 10 may also include an auger and cleaner blade assembly 26 that may remove and collect excess toner that may remain after transferring the toned image onto the print media.

The charge transport layer may specifically include a polymeric binder and a charge transport molecule. Exemplary charge transport molecules may include, for example, hydrazones, tetraphenyl diamines, triaryl amines, benzidines, triphenylmethanes, stilbenes, butadienes, pyrazolines, substituted fluorines, oxadiazoles, as well as various other materials and blends thereof, such as N,N′-bis(3-methylphenyl)-N,N′-diphenylbenzidine (TPD). The charge transport molecule may be present between 5-60% (wt) of the charge transport layer composition.

The polymeric binder may include one or a plurality of polymeric components. For example, the polymeric component may include in a first case any suitable thermoplastic polymer such as an aromatic polycarbonate. Accordingly, the polymers that may be utilized include polyesters, polystyrenes, poly(vinyl chloride), epoxy resins, phenoxy resins, poly(vinyl butyral), vinyl chloride/vinyl acetate copolymers and mixtures thereof. Such polymers may also be selected based upon a desirable molecular weight. For example, the polymeric component may include an aromatic polycarbonate having a number average molecular weight (Mn) in the range of 5,000 to about 200,000, including all values and increments therein, such as 20,000-100,000. Exemplary aromatic polycarbonates may also include bisphenol-A polycarbonate, bisphenol-Z polycarbonate, and combinations and blends thereof.

The polymeric binder may also include an olefin based polymer. The olefin based polymer may be separately provided or prepared in situ during the preparation of a given charge transport solution. Such solution containing dissolved and in situ prepared polymeric binder may then be used to coat the charge generation layer. In addition, the olefin based polymer may be separately polymerized and added to a given charge transport solution. Accordingly, the binder polymer for the charge transport layer may comprise 0.1-99% (wt) of any of the above thermoplastic polymers (e.g., polycarbonate) in combination with 99-0.1% (wt) of an olefin based polymer, including all values and increments therein. For example, the binder may comprise about 10-20% (wt) of an olefin based polymer and 80-90% (wt) of an aromatic polycarbonate.

The olefin based polymer herein may be understood to include any monomer or comonomer combination that is capable of undergoing a metathesis reaction. A metathesis reaction may be understood to include a ring-opening metathesis polymerization (ROMP) or an acyclic diene metathesis polymerization (ADMET). Suitable catalysts for metathesis include Ziegler types prepared from the reaction product of tungsten hexachloride with ethanol and ethyl-aluminum dichloride, WCl₆—(C₂H₅)₃Al. In addition, the olefin based polymer herein may be understood to be sourced from a chain polymerization or a copolymerization of a cycloolefin wherein a monomer containing a chain polymerizable group also includes attachment to cyclic ring structure which ring structure is maintained subsequent to polymerization.

One example of ROMP may be generally illustrated below, in the case of an exemplary norbornene monomer, therein providing a polymer chain containing a repeating unit that includes residual unsaturation, e.g. a non-conjugated —CH═CH— linkage in combination with a hydrocarbon repeat unit, which may include hydrocarbon ring structure. A conjugated repeating linkage may be understood to include, e.g., a polymeric material such as 1,4-polybutadiene. In addition, upon hydrogenation, the repeating unit may comprise a completely saturated hydrocarbon polymer. Furthermore, the cyclic hydrocarbon may itself contain functionality at any location on the polymer chain (e.g. R₁ and/or R₂ as shown below) wherein R₁ and/or R₂ may be the same or different and may be a hydrogen or any desired organic functional group.

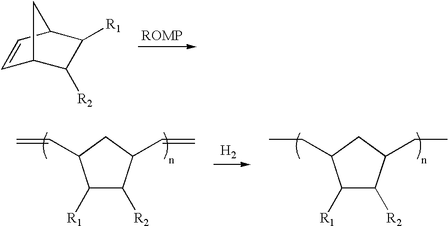

Exemplary substituted norbornenes contemplated for polymerization herein may therefore include 1,4-methano-1,4,4a,9a-tetrahydrofluorene, 1,4-methano-1,4-dihydronaphthalene, 2-acetyl-5-norbornene, 2-methyl-5-norbornene-2-yl acetate, 2-methyl-5-norbornene-2-yl acrylate, 2-methyl-5-norbornene-2-yl methacrylate, 5-(1-chlorodiethoxysilylethyl)-2-norbornene, 5-(1-chlorodimethoxysilylethyl)-2-norbornene, 5-(1-triethoxysilylethyl)-2-norbornene, 5-(1-trimethoxysilylethyl)-2-norbornene, 5-(2-chlorodiethoxysilylethyl)-2-norbornene, 5-(2-chlorodimethoxysilylethyl)-2-norbornene, 5-(2-triethoxysilylethyl)-2-norbornene, 5-(2-triethoxysilylpropyl)-2-norbornene, 5-(2-trimethoxysilylethyl)-2-norbornene, 5-(2-trimethoxysilylpropyl)-2-norbornene, 5-(3-triethoxysilylpropyl)-2-norbornene, 5-(3-trimethoxysilylpropyl)-2-norbornene, 5,5-dimethyl-2-norbornene, 5,6-dimethyl-2-norbornene, 5-allyl-2-norbornene, 5-benzylnorbornene, 5-biphenyl-2-norbornene, 5-butyl-2-norbornene, 5-chlorodiethoxysilyl-2-norbornene, 5-chlorodimethoxysilyl-2-norbornene, 5-chloroethoxymethylsilyl-2-norbornene, 5-chloromethoxymethylsilyl-2-norbornene, 5-cyclohexenyl-2-norbornene, 5-cyclohexyl-2-norbornene, 5-decyl-2-norbornene, 5-dichloroethoxysilyl-2-norbornene, 5-dichloromethoxysilyl-2-norbornene, 5-diethoxyhydrosilyl-2-norbornene, 5-dimethoxyhydrosilyl-2-norbornene, 5-Page 6 of 18-diphenoxymethylsilyl-2-norbornene, 5-dodecyl-2-norbornene, 5-ethoxydiethylsilyl-2-norbornene, 5-ethoxydimethylsilyl-2-norbornene, 5-ethyl-2-norbornene, 5-ethylidene-2-norbornene, 5-hexyl-2-norbornene, 5-isopropyl-2-norbornene, 5-isopropylidene-2-norbornene, 5-methoxydimethylsilyl-2-norbornene, 5-methoxymethylhydrosilyl-2-norbornene, 5-methyl-2-norbornene, 5-methyl-5-ethyl-2-norbornene, 5-methyl-5-phenyl-2-norbornene, 5-methylidene-2-norbornene, 5-naphthyl-2-norbornene, 5-norbornene-2,3-dicarboxylic anhydride, 5-norbornene-2-yl acetate, 5-octyl-2-norbornene, 5-pentyl-2-norbornene, 5-phenyl-2-norbornene, 5-propyl-2-norbornene, 5-t-butyl-2-norbornene, 5-tribromosilyl-2-norbornene, 5-trichlorosilyl-2-norbornene, 5-triethoxysilyl-2-norbornene, 5-triethoxysilylmethyl-2-norbornene, 5-trifluorosilyl-2-norbornene, S-triisopropoxysilyl-2-norbornene, 5-trimethoxysilyl-2-norbornene, 5-trimethoxysilylmethyl-2-norbornene, 5-triphenoxysilyl-2-norbornene, 5-tripropoxysilyl-2-norbornene, 5-vinyl-2-norbornene, 8-ethyltetracyclo-[4.4.0.12,5.17,10]-3-dodecene, 8-methyltetracyclo-[4.4.0.12,5.17,10]-3-dodecene, diethyl S-norbornene-2,3-dicarboxylate, dimethoxymethylsilylpropyl 2-methyl-5-norbornene-2-carboxylate, dimethoxymethylsilylpropyl 5-norbornene-2-carboxylate, dimethyl 5-norbornene-2,3-dicarboxylate, ethyl 2-methyl-5-norbornene-2-carboxylate, ethyl 5-norbornene-2-carboxylate, methyl 2-methyl-5-norbornene-2-carboxylate, methyl 5-norbornene-2-carboxylate, methyl 8-methyl-3-tetracyclo[4.4.0.12,5.17,10]dodecene-8-carboxylate, t-butyl 2-methyl-5-norbornene-2-carboxylate, t-butyl 5-norbornene-2-carboxylate, tetracyclo[4.4.0.12,5.17,10]-3-dodecene, tricyclo[4.3.0.12,5]-3-decene, tricyclo[4.4.0.12,5]-3-undecene, tricyclo[4.3.0.12,5]-3,7-decadiene (dicyclopentadiene), triethoxysilylpropyl 2-methyl-5-norbornene-2-carboxylate, triethoxysilylpropyl 5-norbornene-2-carboxylate, trifluoromethyl 2-methyl-5-norbornene-2-carboxylate, trimethoxysilylpropyl 2-methyl-5-norbornene-2-carboxylate, trimethoxysilylpropyl S-norbornene-2-carboxylate, and the like.

It should also be appreciated herein the ring opening metathesis polymerization may be applied to monomers containing a single carbon-carbon type double bond wherein the resulting polymer includes non-conjugated residual unsaturation in combination with acyclic hydrocarbon repeating units, wherein m below has a value greater than 2:

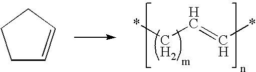

Commercial examples of ROMP include polyalkenamers such as polynorbornene, polyoctenamer and polydicylcopentadiene. Polynorbornene is available from Arkema Group under the trade name Norsorex®. Polyoctenamer is available from Degusa® under the trade name Vestenamer® and amounts to the metathesis polymerization of cycloctene that produces both linear and cyclic macromolecules and is available at different levels of crystallinity. Polydicyclopentadiene is available from Metton America as well as Materia under the trade name Telene®.

In addition, as noted above, the present invention also contemplates the use of acyclic diene metathesis polymerization (ADMP) wherein an olefin monomer containing carbon-carbon double bonds may be polymerized to provide a non-conjugated —CH═CH— linkage in combination with (—CH₂—)ₙ type linkage. As illustrated below, the value of n may be 2. However, n may have a value of 1-10, including any individual value or range therein:

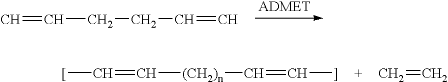

Furthermore, as noted above, it may be understood that the olefin based polymer herein may be sourced from a chain polymerization or copolymerization of a cycloolefin wherein a monomer containing a chain polymerizable group also includes attachment to cyclic ring structure which ring structure is maintained subsequent to polymerization. That is, a poly(cycloolefin) polymer is formed wherein the ring may attach to the carbon atoms forming the repeating unit of the main polymer chain.

Such chain polymerization may be accomplished by free radical, ionic or coordination (e.g. Ziegler/Natta) type chemistry. The polymerization may be illustrated below, wherein R₁ and/or R₂ may be the same or different and may be a hydrogen or any organic functional group and m is an integer and may have, e.g. a value of 1-10 and n is any suitable integer representing the number of repeat units in a given polymer chain:

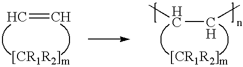

For example, in the particular case of the cycloolefin monomer cyclopentene, chain polymerization would proceed as follows:

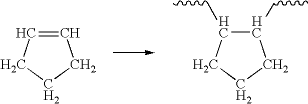

A further example of the above would therefore include chain polymerization of a norbornene type monomer, including any of the norbornene monomers previously noted, as illustrated below, wherein R₁ and R₂ may once again be the same or different, and n is any suitable integer representing the number of repeat units in a given polymer chain:

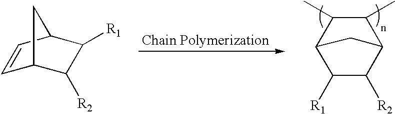

Moreover, consistent with the above, the norbornene may be copolymerized with another chain polymerizable monomer, which is illustrated below in the case of copolymerization with ethylene, wherein R₁ and R₂ may once again be the same or different and m and/or n may be any suitable integer representing the number of repeat units in the exemplary copolymer chain:

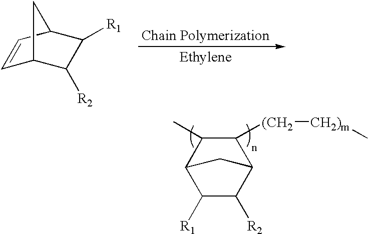

Suitable commercial cyclic olefin polymers (COP) and/or copolymers (COC) produced by the above polymerization type chemistry (e.g. chain polymerization of a cycloolefin wherein a monomer containing a chain polymerizable group also includes attachment to cyclic ring structure which ring structure is maintained subsequent to polymerization) would contemplate TOPAS® cycloolefin copolymer which is an amorphous transparent copolymer sourced from copolymerization of norbornene and ethylene. Other commercial examples would include Zeonex® and Zeonor® available from Zeon Corporation and Apel® from Mitsui Chemicals.

### Preparation of CTL Solution

Any one of the above olefin based polymers may therefore be incorporated as a binder resin on or within a photoconductive surface. More specifically, the olefin based polymer may be incorporated on or into the CTL layer of a photoconductive surface by at least two general methods.

Initially the olefin based polymer may be preformed and then introduced during preparation of a charge transport solution which may then be utilized to coat the CGL layer of a given photoconductor. For example, the olefin based polymer may be introduced and dissolved into an appropriate solvent along with a selected amount of a charge transport molecule(s). As alluded to above, one may then optionally include another polymeric component, wherein the olefin based polymer, either alone or in combination with such polymeric component, may ultimately serve as the binder for other components of the CTL solution. Accordingly, such solution may then be coated on a given CGL layer to provide a CTL layer of a desired thickness.

In addition one may prepare the olefin based polymers disclosed herein by conducting the appropriate polymerization reaction in the solvent medium which may include the charge transport molecule(s) and optionally other appropriate additives, including a secondary preformed polymer component. Such in situ preparation and polymerization of a monomer to form the olefin based polymer in the CTL solution may therefore provide improved solubility of the olefin based polymer as well as improved ability to coat a given CGL surface.

The examples presented below are therefore for purposes of illustration, as other examples may be contemplated based upon the discussion herein. Furthermore, those skilled in the art will now be able to determine and select those particular types olefin based polymer(s), as well as those optional secondary polymeric component(s), along with charge transport additives, etc., for a given manufacturing and/or image forming device performance requirement.

### EXAMPLE 1

### Preparation of a Charge Transport Layer Via In Situ Polymerization and Formation of Olefin Based Polymer

Norbornene (16.85 g/0.18 mol) is dissolved in 484 mL of tetrahydrofuran and 128 mL of dioxane. Bis(tricyclohexylphosphine) benzylidine ruthenium (IV) chloride (5.7 mg), dissolved in 1 mL of tetrahydrofuran, is added to the norbornene with stirring at room temperature to form polynorbornene. After 2 hours, 0.51 g of benzaldehyde is added to the reaction mixture. Then bisphenol-Z polycarbonate (94.98 g) is added, followed by 60.18 g of N,N′-bis(3-methylphenyl)-N,N′-diphenylbenzidine and 6 drops of Dow Corning® 56 Additive, with stirring until all the components completely dissolved. The solution is coated on top of a charge generation layer using a dip coating apparatus. The coating thickness is varied between 20 to 30 microns.

### EXAMPLE 2

### Preparation of a Charge Transport Layer without an Olefin Based Polymer

N,N′-bis(3-methylphenyl)-N,N′-diphenylbenzidine (TPD) (24.5 g) is added to a mixture of 259 ml of tetrahydrofuran and 68 ml 1,4-dioxane and dissolved with stirring. Once the TPD is completely dissolved, 45.5 g of bisphenol-Z polycarbonate and 6 drops of Dow Corning® 56 Additive is added to the solution and stirring is continued until all components are completely dissolved. The resulting solution is coated on the charge generation layer as in Example 1.

A photoconductor drum of Example 1, tested in a modified Lexmark C752 color laser printer at 32 ppm, in a two page and pause mode at 78° F. and 80% relative humidity exhibited a wear rate of 0.41 microns per 1000 pages over 10,000 pages. The photoconductor drum of Example 2, tested under similar conditions exhibited a wear rate of 0.67 microns per 1000 pages over 10,000 pages. Accordingly, the wear of the drum of Example 1 exhibit 60% of the wear exhibited by the drum of Example 2.

The foregoing description is provided to illustrate and explain the present invention. However, the description hereinabove should not be considered to limit the scope of the invention set forth in the claims appended hereto.

What is claimed is:

1. A photoconductor comprising an olefin based polymer wherein said olefin based polymer comprises a polymer formed from a metathesis polymerization of an olefin or chain polymerization of a cycloolefin.

2. The photoconductor of claim 1 wherein said olefin based polymer formed from a metathesis polymerization of an olefin comprises a repeating unit that contains non-conjugated carbon-carbon unsaturation in combination with a hydrocarbon repeat unit.

3. The photoconductor of claim 1 wherein said olefin based polymer formed from a metathesis polymerization of an olefin comprises a repeating unit that contains non-conjugated carbon-carbon unsaturation in combination with a cyclic hydrocarbon repeat unit.

4. The photoconductor of claim 1 wherein said olefin based polymer comprises a polynorbornene of the following structure: 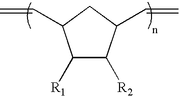
wherein R₁ and R₂ are the same or different and comprise hydrogen or an organic functional group.

5. The photoconductor of claim 1 wherein said olefin based polymer comprises a polynorbornene of the following structure: 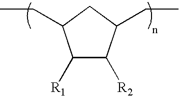
wherein R₁ and R₂ are the same or different and comprise hydrogen or an organic functional group.

6. The photoconductor of claim 1 wherein said olefin based polymer comprises a polymer including the repeating unit: 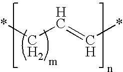
wherein m has a value greater than 2 and n is an integer.

7. The photoconductor of claim 1 wherein said olefin based polymer comprises a polymer formed from a chain polymerization of a cycloolefin to form a poly(cycloolefin) having the repeating unit: 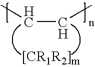
where m has a value greater than 1, n is an integer, and wherein R₁ and R₂ are the same or different and comprise hydrogen or an organic functional group.

8. The photoconductor of claim 1 wherein said olefin based polymer comprises a polymer formed from a chain polymerization of a cycloolefin to form a poly(cycloolefin) having the repeating unit: 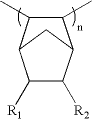
where n has a value greater than 1 and wherein R₁ and R₂ are the same or different and comprise hydrogen or an organic functional group.

9. The photoconductor of claim 1 wherein said olefin based polymer comprises a copolymer formed from the chain polymerization of a cycloolefin to form a poly(cycloolefin) having the repeating unit: 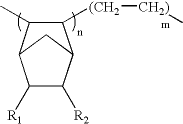
wherein n and m are integers.

10. The photoconductor of claim 1 further including a thermoplastic polymer component.

11. The photoconductor of claim 1 further including a thermoplastic polymer component wherein said polymer has a number average molecular weight of about 5,000-200,000.

12. The photoconductor of claim 1 further including a polymer selected from the group consisting of polycarbonates, polyesters, polystyrenes, poly(vinyl chlorides), epoxy resins, poly(vinyl butyral) and poly(vinylchloride)/poly(vinyl acetate) copolymers, and mixtures thereof.

13. The photoconductor of claim 1 wherein said photoconductor includes a charge transport layer capable of transporting either negative or positive charges and said charge transport layer includes said olefin based polymer.

14. The photoconductor of claim 1 wherein said photoconductor is positioned in an image forming apparatus.

15. The photoconductor of claim 1 wherein said photoconductor is positioned in a printer cartridge.

16. A method of forming a solution for coating a photoconductive surface:
adding to a solvent a polymer formed from a metathesis polymerization of an olefin or chain polymerization of a cycloolefin; and
coating a photoconductive surface with said solution.

17. The method of claim 16 wherein said coating is about 5-50 microns in thickness.

18. The method of claim 16 wherein said step of adding said polymer to said solvent comprises a metathesis polymerization of a monomer to form said polymer in said solvent.

19. The method of claim 16 wherein said step of adding said polymer to said solvent comprises a chain polymerization of a cycloolefin monomer to form said cycloolefin polymer in said solvent.

20. The method of claim 18 wherein said monomer has the following structure: 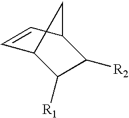
wherein R₁ and R₂ are the same or different and comprise hydrogen or an organic functional group.

21. The method of claim 19 wherein said monomer has the following structure: 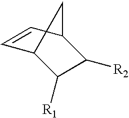
wherein R₁ and R₂ are the same or different and comprise hydrogen or an organic functional group.

22. The method of claim 16 including the step of adding a charge transport molecule to said solvent wherein said photoconductive surface includes a charge generation layer and said step of coating including coating said charge generation layer and forming a charge transport layer.
